(19) United States
(12) Patent Application Publication
(10) Pub. No.: US 2018/0345270 A1
(43) Pub. Date: Dec. 6, 2018

(54) Pipette Controller with Retractable Stand

(71) Applicants: Michael James Demsia, Hoboken, NJ (US); Fredrick Ree, Edison, NJ (US)

(72) Inventors: Michael James Demsia, Hoboken, NJ (US); Fredrick Ree, Edison, NJ (US)

(21) Appl. No.: 15/615,832

(22) Filed: Jun. 6, 2017

(51) Int. Cl. B01L 3/02

(52) U.S. Cl. CPC B01L 3/021; B01L 2300/06; B01L 2200/02

(57) ABSTRACT

A pipette controller with retractable stand includes a frame having a front end with a pipette connector and a rear end with a handle; a flat, lower surface on the handle; a retractable kickstand having arms and a arc-shaped base, rotatably fixed to the frame; an extended position retaining element on the frame having a pair of flanges that releasably retain the arms of the kickstand in the extended position; and an arc-shaped portion of the frame the corresponds to the base of the kickstand to provide a retracted position retaining element.

### BACKGROUND OF THE INVENTION

The present invention generally relates to laboratory equipment and more specifically to a pipette controller with a retractable stand.

A pipette controller is an instrument that serves to aspirate and dispense large or small volumes of liquid. An electric pipette controller may be shaped like a pistol, having a handle with trigger-like control buttons and a pipette connector at the front. A pipette is attached and the user holds the handle and squeezes the triggers to aspirate or dispense liquid in the pipette.

It may be awkward or inconvenient to set the controller down when it has a long pipette attached. If the tip of the pipette is allowed to come in contact with surfaces, such as a table, the contents of the pipette may become contaminated or leak. Removable stands might help prop the controller up, but removable stands are easily lost or inconveniently separated from the controller.

It would be desirable to have a pipette controller with a built-in stand that can retract out of the way without being detached.

### SUMMARY OF THE INVENTION

In one aspect of the present invention, a pipette controller includes a frame having a front end with a pipette connector and a rear end with a handle; a flat, lower surface on the handle; and a retractable kickstand, fixed to the frame; wherein the kickstand extends past the rear end of the frame and cooperates with the lower surface on the handle to provide a stand.

In another aspect of the present invention, a pipette controller includes a frame having a front end with a pipette connector and a rear end with a handle; a flat, lower surface on the handle; a retractable kickstand having arms and an arc-shaped base, rotatably fixed to the frame; an extended position retaining element on the frame having a pair of flanges that releasably retain the arms of the kickstand in the extended position; and an arc-shaped portion of the frame the corresponds to the base of the kickstand to provide a retracted position retaining element.

In yet another aspect of the present invention, a retractable stand for a pipette controller includes a metal bar having two arms and an arc-shaped base; an angled arm segment on each arm at a different angle from the rest of the arm; and an attachment extension at a right angle at the end of the angled arm segment; wherein the attachment extensions are adapted to rotatably attach to a pipette controller so that the base retracts against the pipette controller and then extends to provide a stand for the pipette controller.

### BRIEF DESCRIPTION OF THE DRAWINGS

FIG. 1 depicts a side view of an embodiment of a device according to the present invention, in a retracted position;

FIG. 2 depicts a side view of the embodiment of FIG. 1 in an extended position;

FIG. 3 depicts a top view of the kickstand of the embodiment of FIG. 1;

FIG. 4 depicts an oblique view of the kickstand of the embodiment of FIG. 1;

FIG. 5 depicts a front view of a portion of the embodiment of FIG. 1; and

FIG. 6 depicts a side view of a portion of the embodiment of FIG. 1.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

An embodiment of the present invention generally provides a pipette controller with a retractable stand, or alternatively, a retractable stand for a pipette controller.

Embodiments of a pipette controller may have a handle with trigger-like control buttons, a frame with an upper frame similar to the barrel or slide of a pistol, and a pipette connector that hangs down from the end of the upper frame. Embodiments of an electric pipette controller may be battery or AC powered, may be rechargeable, and may include a variable speed adjustment control. Embodiments of a pipette connector may include a replaceable nosepiece made of silicone or other autoclavable plastics for easy sterilization. The connector may accommodate pipettes from, for example, lml to 100m1, and may include a replaceable filter.

Embodiments of a retractable stand attachment or a foldable kickstand may be attached to a pistol-like electric pipette controller. The kickstand may rotate from a completely retracted, neutral position to an extended position. The kickstand may be rotatably attached at the rear of the device, so it can provide a stand in the extended position, fold out of the way in the retracted position, and not interfere with the pipette at the front of the device. The kickstand may allow the controller to be sat on a surface, such as a table, and rest at an angle such that the open tip of the pipette does not come in contact with the table. The pipette may be suspended in the air so that it does not make contact with any surface, thus preventing contamination or cross-contamination of the contents of the pipette.

An embodiment of a kickstand may include a single metal bar, with two arms, and a horseshoe-shaped base. The arms may be attached to sides of the rear, upper body of the controller, above the handle, a short distance below the top of the controller. The base may include a horseshoe shaped arch that conforms to a retaining element on the front, upper body of the controller, so the kickstand clips in place, out of the way, in the retracted or folded position. In the extended position, the base of the kickstand and the bottom of the handle of the controller cooperate to form a stable, tripod-like stand.

Embodiments of a stand attachment may be an integrated part of the controller, or may be detachable. Embodiments may be permanently fixed to the controller, or may be removably attached, but in either case embodiments may have a retracted position and an extended position. Embodiments may include a pair of apertures on the sides of the upper housing of the controller, and small extensions on the ends of the two arms of the kickstand that point toward each other, so that the natural springiness of the metal kickstand urge the ends of the arms toward each other, firmly into the apertures on the controller.

To use an embodiment, a user may retract the stand so the user can grasp the handle of the controller. The user attaches a long pipette to a connector on the nosepiece of the controller and squeezes the trigger-like control buttons to precisely aspirate or dispense liquid.

Embodiments of a lower stand surface, a flat portion at the back, bottom of the handle, will not interfere with the user's grasp of the handle. The user may then extend or swing-out the stand so that the user can set the controller down with the pipette still attached, such as on a table or bench top. The stand will prop up the pipette and pipette controller at a previously-specified angle, so that it does not allow the pipette to come into contact a surface, such as a table, when the device is sat on the surface. The kickstand may be provided as an add-on for a pipette controller, or an electronic pipette controller may be provided that already has a kickstand attached. Embodiments of a pipette controller with retractable kickstand may be balanced or weighted so that it does not tip over with the long pipette attached. Each side of the upper frame may have portions at the front and rear that retain the kickstand in, respectively, retracted and extended positions.

A retracted position retaining element on the frame may include notches in sides of the frame that correspond to the arms of the kickstand. Each side of the upper frame may have a section that forms a trough, that helps retain one arm of the kickstand in the retracted position. The retracted position retaining element may include a rounded top or “barrel” that corresponds to the rounded base of the kickstand. The sides and top of the upper frame may thus correspond to the kickstand so that the kickstand snaps into in a folded, stored, or retracted position.

An extended position retaining element on the upper frame may include a pair of short, parallel flanges on each side of the upper frame. Each side of the upper frame may have a section that forms a channel, that helps retain one arm of the kickstand in the extended position.

The user may urge or snap the kickstand into the retracted position against the rounded top, and then pull the kickstand out until it snaps it into the extended position. The flanges hold the kickstand in the extended position so that the kickstand extends out from the device. The base of the kickstand and a lower, rear portion of the handle cooperate to provide a stable stand for the pipette controller.

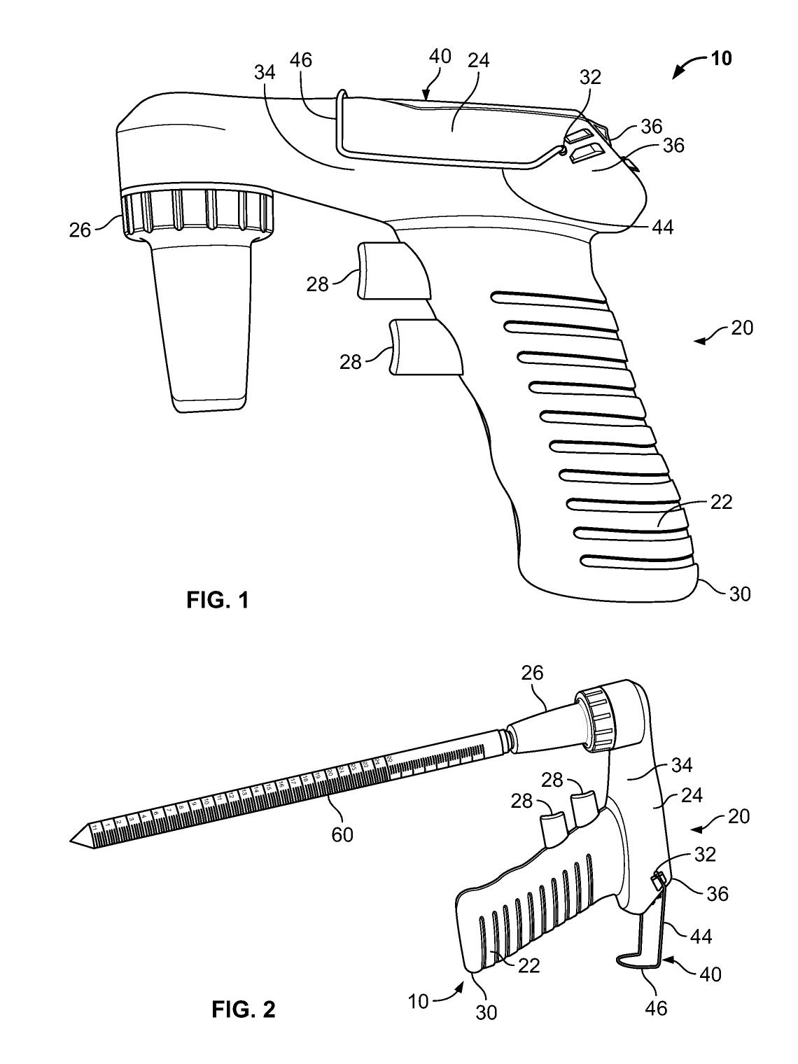

As depicted in FIGS. 1 and 2, an embodiment of a pipette controller with retractable stand or device 10 may include a pipette controller 20 and a kickstand 40.

Pipette controller 20 may include a handle 22, an upper frame 24, and a pipette connector 26 at an end of the upper frame opposite the handle. The pipette connector 26 may extend down from an underside of the upper frame 24, and may be adapted to hold a pipette 60 generally perpendicular to a major axis of the upper frame. The handle 22 may have one or more trigger-like control buttons 28 on a front side and a lower stand surface 30 on a back side. The control buttons 28 may be trigger-like columns that are be urged into the handle by a user's fingers.

Embodiments of a device may include an upper frame 24 having a rear portion with attachments points 32, such as small round apertures, for kickstand 40. Embodiments may have retracted position retaining elements 34, such the shape of the upper frame 24, that help hold the kickstand 40 in the retracted position. Embodiments may have extended position retaining elements 36, such as flanges at the back of the upper frame 24, that help retain the kickstand 40 in the extended position.

FIG. 1 depicts an embodiment of a device 10 in a retracted position. Retracted position retaining elements 34 may help keep the arms of the kickstand in a folded, stored, or retracted position against the upper frame 24. Retracted position retaining elements 34 may include sides of upper frame 24 that correspond to arms 44 of kickstand 40, and a rounded top on upper frame 24 that corresponds to a rounded base 46 of the kickstand 40.

FIG. 2 depicts an embodiment of a device 10 in an extended position. The kickstand 40 may swivel about attachment points 32 in the upper frame 24 from the retracted position into the extended position. When kickstand 40 is extended, kickstand 40 extends past the rear of upper frame 24 so that the base 46 of kickstand 40 and the lower stand surface 30 of handle 22 cooperate to form a stable, tripod-like stand. Extended position retaining elements 36 may include a pair of short, parallel flanges or bulges on each side of the upper frame, that help retain the arms 44 of the kickstand in the extended position. The flanges may hold arms 44 of kickstand 40 in the extended position so that base 46 extends out from the pipette controller 20, and the base 46 and a lower stand surface 30 on the handle may cooperate to provide a stand. The stand may hold the device at a previously-specified, stable angle, so that a pipette 60 will be held at an angle of between 15 degrees to 45 degrees, preferable 20 degrees. At this angle, pipette 60 may be suspended in the air and avoid contact with any surface upon which the stand is sat, helping avoid cross contamination.

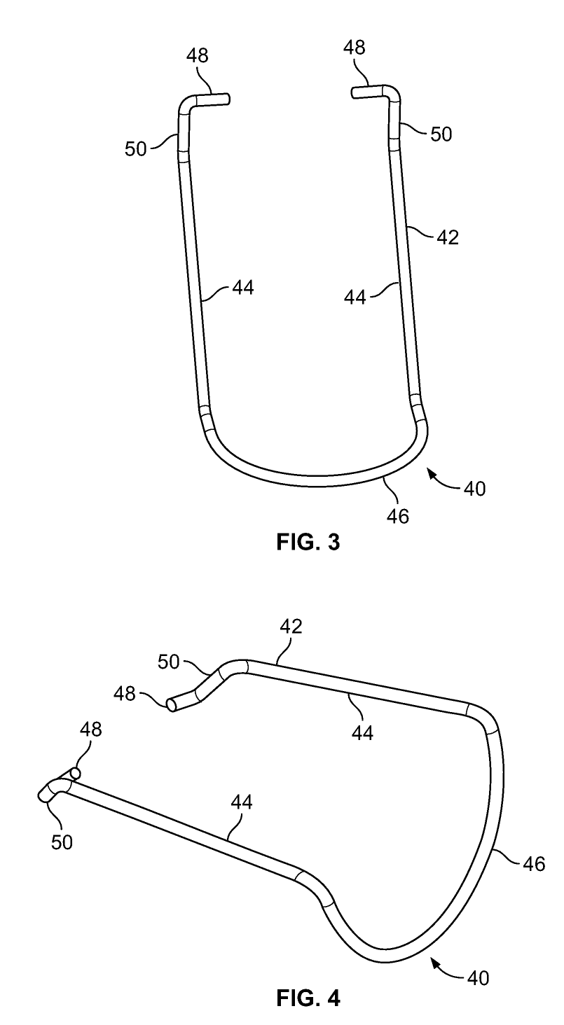

FIGS. 3 and 4 depict an embodiment of a kickstand 40. The kickstand 40 may include a metal bar 42 with two arms 44, and an arc-shaped, round, or horseshoe-shaped base 46. Arms 44 may be attached at attachment points on sides of the upper frame of a pipette controller, near the rear and a short distance below the top of the upper frame. The base 46 may include a horseshoe shaped or round arch that conforms to the top of the upper frame. The arms 44 and base 46 correspond to the retracted position retaining elements on the pipette controller so that the kickstand clips in place when the device is in the retracted position. Each arm 44 may have an angled arm segment 50 at a different angle from the rest of the arm 44 and an attachment extension 48 at a right angle at the end of the angled arm segment 50 that points directly in toward the frame. This allows the kickstand 40 to be retained by flanges in the upper frame at an angle that aligns with attachments points in the upper frame, yet hold the arms of the kickstand so that the arms point vertically down to hold the base flat against a table or stand when the device is in the extended position.

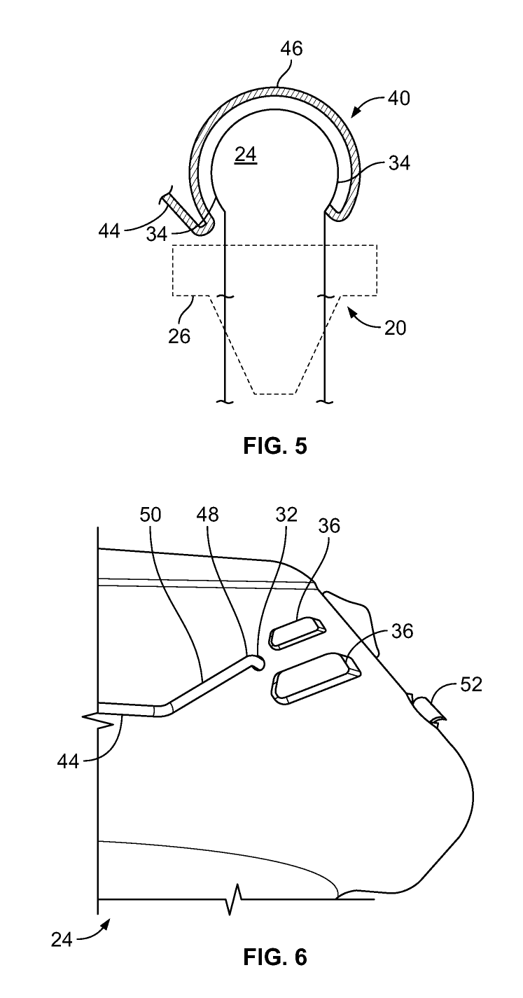

FIG. 5 depicts an embodiment of a pipette controller 20 with a kickstand 40 in the retracted position. An arc-like shape of base 46 may correspond to a corresponding arc-like shape of upper frame 24, thereby providing one or more retracted position retaining elements 34 to hold the kickstand 40 in place. A lowest portion of an arc of base 46 may extend slightly below an outermost bulging portion of upper frame 24 so that kickstand 40 will gently snap into place, yet not interfere with the pipette connector 26. In other embodiments, retracted position retaining elements 34 may include slots or grooves to help retain the arms 44 of kickstand 40.

FIG. 6 depicts an embodiment of an upper frame 24 with extended position retaining elements 36. The rear portion of an upper frame 24 may have attachments points 32 such as small apertures. Each arm 44 of the kickstand may have an angled arm segment 50 at a different angle from the rest of the arm 44, and an attachment extension 48 at the end of the angled arm segment 50 that points directly in toward the frame, at a right angle to the arm 44, so that it may be rotatably attached to the attachments points 32. The extended position retaining elements 36 may include two short, parallel flanges that form a channel that correspond the arms 44 of the kickstand. The arms 44 could be rotated so that the arms snap into the channel, thereby helping retain the kickstand in the extended position. In an embodiment, the channel may directly align with the attachments points 32, and the arms 44 may have angled arm segments 50. Embodiments may avoid interference with control switches 52 on the back of upper frame 24.

I claim:

1. A pipette controller comprising:
a frame having a front end with a pipette connector and a rear end with a handle;
a flat, lower surface on the handle; and
a retractable kickstand, fixed to the frame;
wherein the kickstand extends past the rear end of the frame and cooperates with the lower surface on the handle to provide a stand.

2. The controller of claim 1, wherein the stand is adapted to be sat on a surface and the frame will retain a pipette suspended in the air at an angle so that the pipette does not come in contact with the surface.

3. The controller of claim 1, wherein the stand supports the frame in an upright position so that the pipette connector retains a pipette at an angle of between 15 degrees and 45 degrees below horizontal.

4. The controller of claim 1, wherein the kickstand has arms attached to the frame so that the kickstand rotates between a retracted position, where the kickstand is held to the frame, and an extended position, where the kickstand extends past the rear end of the frame.

5. The controller of claim 1, further comprising an extended position retaining element on the frame that releasably retains the kickstand so that a base of the kickstand extends past the rear end of the frame, and the base cooperates with the lower surface on the handle to provide the stand.

6. The controller of claim 1, further comprising:
an arm on the kickstand that rotatably attaches to the frame, and
a pair of parallel flanges on a side of the frame that help retain the arm in an extended position.

7. The controller of claim 1, further comprising:
a first arm on the kickstand that rotatably attaches to a left side of the frame;
a first pair of parallel flanges on the left side of the frame that help retain the first arm in an extended position;
a second arm on the kickstand that rotatably attaches to a right side of the frame;
a second pair of parallel flanges on the right side of the frame that help retain the second arm in an extended position; and
a base on the kickstand between the first arm and second arm that extends past the rear end of the frame and cooperates with the lower surface on the handle to provide the stand.

8. The controller of claim 1, wherein the kickstand has a base with an arc-like shape that corresponds to an arc-like shape of the frame, thereby providing a retracted position retaining element.

9. The controller of claim 1, wherein:
the kickstand has two arms and a base;
each arm has an angled arm segment at a different angle from the rest of the arm;
each angled arm segment has an attachment extension at a right angle to the arm;
the frame has extended position retaining elements that retain the angled arm segments in an extended position; and
the frame has attachment points that align with extended position retaining elements so that the arms point back, away from the handle when the kickstand is extended yet point toward the front end of the frame when the kickstand is retracted.

10. The controller of claim 1, wherein:
the kickstand has a base shaped like an arc; and
a lowest portion of the arc of the base extends below an outermost bulging portion of the frame so that the kickstand will be held in the retracted position.

11. A pipette controller comprising:
a frame having a front end with a pipette connector and a rear end with a handle;
a flat, lower surface on the handle;
a retractable kickstand having arms and a arc-shaped base, rotatably fixed to the frame;
an extended position retaining element on the frame having a pair of flanges that releasably retain the arms of the kickstand in the extended position; and
an arc-shaped portion of the frame the corresponds to the base of the kickstand to provide a retracted position retaining element.

12. A retractable stand for a pipette controller, comprising:
a metal bar having two arms and an arc-shaped base;
an angled arm segment on each arm at a different angle from the rest of the arm; and
an attachment extension at a right angle at the end of the angled arm segment;
wherein the attachment extensions are adapted to rotatably attach to a pipette controller so that the base retracts against the pipette controller and then extends to provide a stand for the pipette controller.
